(19) United States
(12) Patent Application Publication
(10) Pub. No.: US 2008/0257115 A1
(43) Pub. Date: Oct. 23, 2008

(54) BOLT-FASTENING APPARATUS AND METHOD

(75) Inventor: Akihiro Yoshikawa, Hagagun (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/017,509

(22) Filed: Jan. 22, 2008

(30) Foreign Application Priority Data
Jan. 23, 2007 (JP) 2007-012567
Nov. 2, 2007 (JP) 2007-285668

(51) Int. Cl. B25B 13/48

(52) U.S. Cl. 81/55; 81/57.44; 81/488

(57) ABSTRACT

An apparatus for fastening a washered bolt with a flat washer passed therethrough, to a fastening object. Air discharged from an air blow nozzle is blown into a space between a head of the bolt accommodated in a socket and the flat washer. Foreign matter will be prevented from adhering to the flat washer and the bolt head.

### FIELD OF THE INVENTION

The present invention relates to an improvement in a bolt fastening technique for holding, conveying and rotating a washered bolt with a flat washer passed therethrough and held in contact with a head of the bolt.

### BACKGROUND OF THE INVENTION

A bolt-fastening apparatus known as a nut runner is an apparatus that has a socket part on a distal end of a rotating shaft. A head of a bolt is chucked and held in the socket part by magnetic chucking or vacuum chucking. The bolt is conveyed and fastened to an object to be fastened.

When the object to be fastened is an aluminum alloy, a copper alloy, or another material that is softer than steel, the object to be fastened may buckle, and a washer is therefore preferably used. This is because surface pressure can be reduced by using a washer.

A washer is also used when a risk arises that the head of the bolt may fall through a bolt hole because the bolt hole is too large. Washers are thus used for a variety of reasons. Washers are used in a variety of modes; e.g., flat washers, spring washers, lock washers, and tab washers. However, flat washers that are formed from a punched-out flat plate constitute a majority of washers.

If a washer is provided in advance to the object to be fastened, and the bolt is passed through the washer, the bolt can be fastened using a conventional nut runner. However, extra effort is required to position the washer in advance. If the distal end of the bolt accidentally comes into contact with the washer when the bolt is passed therethrough, the washer will be knocked off.

A bolt-fastening apparatus is disclosed in Japanese Patent Application Laying-Open Publication No. 08-99283 (JP 08-99283 A), wherein a bolt is held, conveyed, and rotated in a mode in which the bolt is passed through a flat washer, and the a head of the bolt is in contact with the flat washer, whereby the inconveniences described above are resolved.

This bolt-fastening apparatus will be described below with reference to FIGS. 9A and 9B hereof.

As shown in FIG. 9A, a chucking head 101 has an air channel 102 and a concavity 105 for accommodating a head 104 of a bolt 103 shown by the imaginary line. As shown in FIG. 9B, the chucking head 101 has two gap parts 106, 106 that are formed by being cut out.

According to FIGS. 9A and 9B, an air compressor 107 is operated and air in the concavity 105 and the gap parts 106, 106 is suctioned via the air channel 102. A head 104 of the bolt is what is primarily chucked in the air channel 102, and a flat washer 108 is chucked by the gap parts 106, 106.

However, in addition to the air, dust, metal shavings, or other foreign matter enters the concavity 105 and the gap parts 106, 106. Some of the foreign matter may adhere to the flat washer 108, and fastening failure may occur. Large quantities of air must be suctioned in order to increase the chucking force, and operating expenses; i.e., the cost of electricity, for the air compressor 107 increase in proportion to the amount of air that is suctioned.

### SUMMARY OF THE INVENTION

It is therefore an object of the present invention to provide a bolt-fastening technique in which a washered bolt with a flat washer passed therethrough and held in contact with a head of the bolt is held, conveyed and rotated, wherein no concerns arise that foreign matter will be suctioned, and wherein electricity costs can be readily reduced.

According to a first aspect of the present invention, there is provided a bolt-fastening apparatus for holding, conveying and rotating a washered bolt with a flat washer passed therethrough, the apparatus comprising: a rotating shaft; a holder for rotatably supporting the rotating shaft; a socket provided to a distal end of the rotating shaft and designed to accommodate a head of the bolt; and an air blow nozzle provided to the holder for blowing air into a space between the head of the bolt accommodated in the socket and the flat washer.

In this arrangement, air discharged from the air blow nozzle flows between the bolt head and the flat washer. The flow rate increases because the channel between the head of the bolt and the flat washer is narrow. According to Bernoulli's theorem, the sum total of the dynamic pressure and static pressure remains constant. The pressure decreases by the amount that the flow rate increases. When the pressure decreases, the flat washer comes into contact with the bolt head and does not fall off.

Air discharged from the air blow nozzle is thus only made to flow between the bolt head and the flat washer. The discharged air has a cleaning effect, which eliminates any risk of foreign matter adhering to the flat washer or the bolt head. As a result, only a small amount of the air needs to be discharged from the air blow nozzle, and electricity expenses incurred by the compressor can be reduced.

Desirably, the flat washer has a first surface facing the bolt head and an oppositely faced second surface, and the air blow nozzle is provided near the holder so as not to protrude from the second surface at a reference position where the flat washer is held in contact with the head of the bolt accommodated in the socket. Thus, no concerns are presented that the air blow nozzle will come in contact with the object to be fastened. As a result, the bolt can be adequately fastened to the object to be fastened.

According to a second aspect of the present invention, there is provided a bolt-fastening apparatus for holding, conveying and rotating a washered bolt with a flat washer passed therethrough, the apparatus comprising: a rotating shaft; a holder for rotatably supporting the rotating shaft; a hollow slider fitted on an outer periphery of the holder longitudinally movably; a socket provided to a distal end of the rotating shaft and designed to accommodate a head of the bolt; and an air blow nozzle attached to the slider for blowing air in a space between the head of the bolt accommodated in the socket and the flat washer, the slider being slidable longitudinally rearwardly of the holder when an obstruction comes in contact with the air blow nozzle.

In this arrangement, when an obstruction comes in contact with the air blow nozzle, the slider slides toward the rear of the bolt in the longitudinal direction, and the socket is accordingly able to protrude beyond the air blow nozzle. The bolt can thereby be adequately fastened to the threaded hole without any interference from obstructions, even if a protruding part or another obstruction is present on the periphery of a threaded hole provided to the object to be fastened.

According to a third aspect of the present invention, there is provided a method for fastening a washered bolt with a flat washer passed therethrough, comprising the steps of: accommodating a head of the washered bolt inside a socket; causing a rotating shaft, which supports the socket, to rotate; blowing air from an air blow nozzle into a space between the head of the bolt accommodated in the socket and the washer; and fastening the bolt to a fastening object.

In the air blowing step, air is blown from the air blow nozzle into the space between the bolt head and the flat washer. The cleaning air therefore has a cleaning effect. Consequently, no concerns are presented that foreign matter will adhere to the flat washer or the head of the bolt. As another result, only a small amount of the air needs to be discharged from the air blow nozzle, and electricity expenses incurred due to the compressor can be reduced.

### BRIEF DESCRIPTION OF THE DRAWINGS

Certain preferred embodiments of the present invention will be described in detail below, by way of example only, with reference to the accompanying drawings, in which:

FIG. 1 is a schematic view showing an external appearance of a bolt-fastening apparatus according to a first embodiment of the present invention;

FIG. 2 is a schematic view showing a socket of FIG. 1 in association with a flange bolt passed through a flat washer;

FIG. 3 is a perspective view as seen from the direction of arrow 3-3 of FIG. 2;

FIG. 4 is a cross-sectional view illustrating a state in which the washered bolt is installed in the socket of FIG. 2, with the bolt being fastened to an object to be fastened;

FIGS. 5A and 5B are side elevational views showing a state in which air is discharged between a head of the bolt and the flat washer;

FIG. 6 is a flowchart showing a bolt-fastening method using the bolt-fastening apparatus according to the first embodiment;

FIG. 7 is a partial sectional view of a bolt-fastening apparatus according to a second embodiment of the present invention;

FIGS. 8A through 8C are schematic views showing an operation of the bolt-fastening apparatus according to the second embodiment shown in FIG. 7;

FIG. 9A is a cross-sectional view showing a conventional bolt-fastening apparatus; and

FIG. 9B is a perspective view as seen from the direction of arrow 9B of FIG. 9A.

### DETAILED DESCRIPTION OF THE PREFERRED EMBODIMENTS

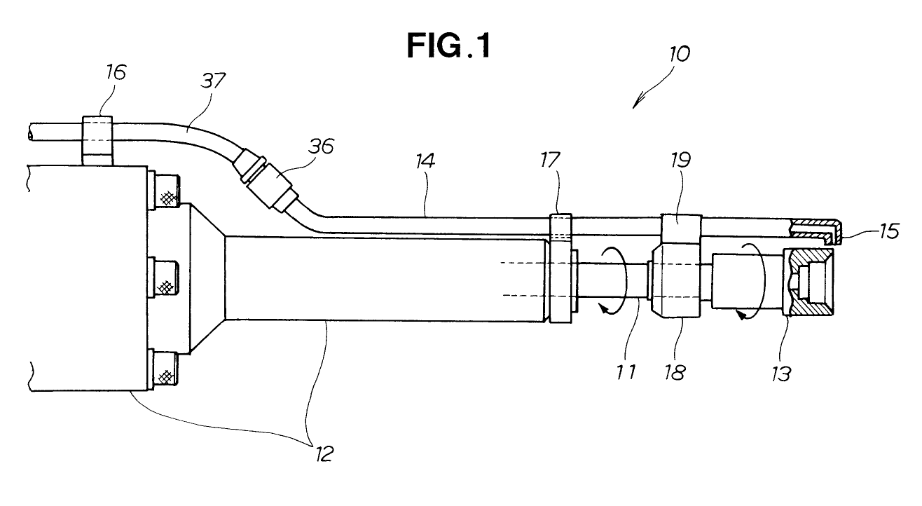

Reference is initially made to FIGS. 1 through 6 showing a bolt-fastening apparatus and a fastening method according to the present invention.

As shown in FIG. 1, the bolt-fastening apparatus 10 has a rotating shaft 11; a holder 12 for rotatably supporting the rotating shaft 11; a socket 13, which is provided to a distal end of the rotating shaft 11, and which accommodates a head of a bolt; an air supply tube 14 attached to the holder 12; and an air blow nozzle 15 provided to a distal end of the air supply tube 14.

The air supply tube 14 is preferably a steel tube, a copper tube, an aluminum tube, or another metal tube. A flexible tube 37 is connected to the air supply tube 14 via a tube joint 36. The flexible tube 37 is fixed to the holder 12 using a tube clamp 16.

A rotating sleeve 18 is attached to the rotating shaft 11 via a bearing. The air supply tube 14 is supported by a clamp part 19 that is provided to the rotating sleeve 18.

The holder 12 has a rotation-stopping member 17, which is provided to a distal end thereof. The rotation-stopping member 17 restricts the air supply tube 14 from moving in the direction that is perpendicular to the plane of the drawing. The rotation-stopping member 17 has, e.g., a two-pronged-fork shape, allowing the air supply tube 14 to move in the longitudinal direction of the rotation-stopping member.

If the socket 13 is capable of moving in a longitudinal direction of the shaft (horizontally within the plane of the drawing) with respect to the holder 12, the air supply tube 14 and the air blow nozzle 15 will move in the longitudinal direction of the shaft along with the socket 13. This movement is absorbed by the flexible tube 37.

Specifically, the air blow nozzle 15 can be set to the position of the socket 13, which is a pre-determined position, even if the socket 13 slides in the longitudinal direction of the shaft. A predetermined amount of air can be stably supplied from the air blow nozzle 15 toward the socket 13.

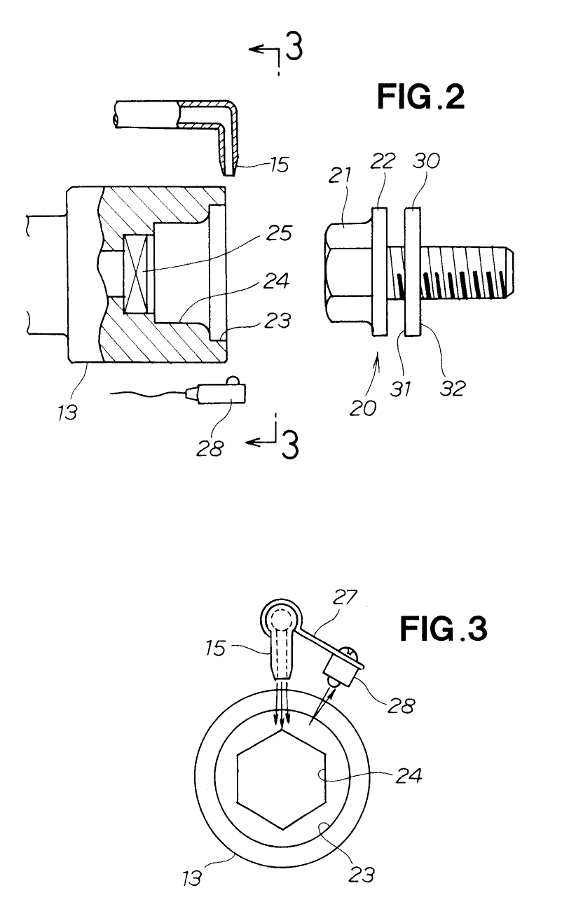

FIG. 2 shows the socket 13 and a flange bolt 20 in which a flange 22 is integrated with a head 21 of the bolt. A flange accommodating part 23 for accommodating the flange 22, and a bolt head accommodating part 24 for accommodating the head 21 of the bolt are formed in the socket 13. A magnet 25 is embedded deep in the interior of the bolt head accommodating part 24.

As shown in FIG. 3, a metal stay 27 extends from the air blow nozzle 15, and a washer detection sensor 28 is attached to the stay 27. The washer detection sensor 28 has a light-emitting element and a light receiving element. The washer detection sensor is preferably a “reflection-type light sensor” in which infrared beams or laser beams emitted from the light-emitting element impinge on the washer, and are reflected. A washer is determined to be present if the reflected light reaches the light-receiving element, and is determined not to be present if the reflected light does not return to the light-receiving element. However, another type of non-contact component detection sensor may be used.

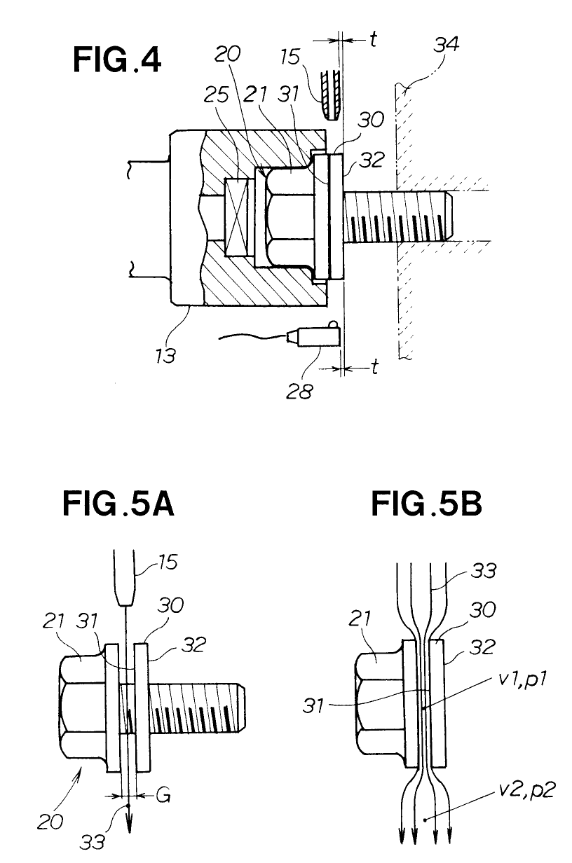

As shown in FIG. 4, the flat washer 30 has a first surface 31 facing the head 21 of the bolt, and a second surface 32 on the opposite side thereof. The second surface 32 of the flat washer 30 is tightly attached to the bolt head 21, which is accommodated in the socket 13. Using the second surface 32 as a reference, the air blow nozzle 15 is disposed near the holder 12 (see FIG. 1) at a distance t so that the air blow nozzle 15 will not protrude beyond the second surface 32. The washer detection sensor 28 is similarly disposed.

If made of carbon steel, the bolt 20 can be chucked by the magnet 25 and accordingly held by the socket 13. The air blow nozzle 15 proposed in the present invention is advantageous when the flat washer 30 is composed of aluminum, copper, austenitic stainless steel, or another non-magnetic material.

The action of the air blow nozzle 15 will be described below with reference to FIGS. 5A and 5B.

As shown in FIG. 5A, air is discharged from the air blow nozzle 15. The air 33 flows between the head 21 of the bolt and the first surface 31 of the flat washer 30. The flow of the air varies as shown in FIG. 5B.

In FIG. 5B, v1 and p1 refer respectively to the flow rate and pressure of the air between the head 21 of the bolt and the flat washer 30. v2 and p2 refer respectively to the flow rate and pressure of the air in locations separated from the head 21 of the bolt.

According to Bernoulli's theorem, (p/γ)+(v²/2 g)+h is constant. γ is the density of the air, and g is gravitational force. h in the third term indicates height (potential). (p/γ) in the first term and (v²/2 g) in the second term are given in the same dimensions (e.g., mm or cm) as h in the third term.

(p1/γ)+(v1²/2 g)+h1=(p2/γ)+(v2²/2 g)+h2, but h1 and h2 are substantially the same. An investigation was accordingly made using the relational expression of (p1/γ)+(v1²/2 g)=(p2/γ)+(v2²/2 g).

p1<p2 because v2<v1. p1 becomes a negative pressure as p2 approaches atmospheric pressure. Accordingly, the flat washer 30 gets closer to the head 21 of the bolt. However, when the flat washer gets extremely close, v1 becomes zero, and the negative pressure disappears. When this happens, the flat washer 30 separates from the head 21 of the bolt.

Specifically, a fixed gap G is present between the head 21 of the bolt and the flat washer 30 shown in FIG. 5A. The gap G varies slightly depending on whether the bolt 20 is horizontal, inclined, or vertical, but the gap remains fixed in each of these positions.

Specifically, air passes between the head 21 of the bolt and the flat washer 30. Therefore no risk is presented that foreign matter will enter therein. Even if any foreign matter were to be present, it would be removed as a result of the cleaning effect of the air.

In FIG. 4, the air blow nozzle 15 and the washer detection sensor 28 do not protrude beyond the second surface 32. When the bolt 20 is threaded into or passed through the object 34 to be fastened, which is shown by the imaginary line, the second surface 32 can come in contact with the object 34 to be fastened without any interference.

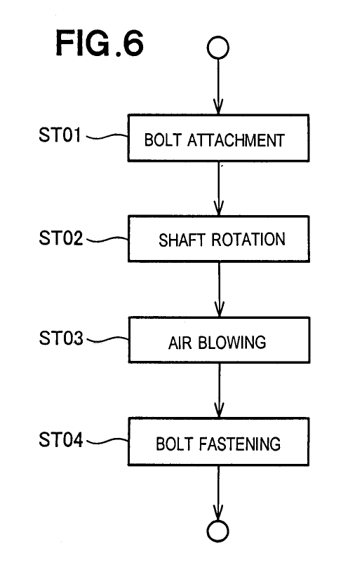

A bolt-fastening method conducted using the bolt-fastening apparatus 10 of the first embodiment will be described below with reference to FIGS. 1, 2, 5A, 5B, and the flow chart in FIG. 6.

In step (indicated hereafter by ST) 01, a bolt is inserted in the socket. Specifically, in FIG. 2, the bolt head 21 and the flange 22 of the flange bolt 20 are fitted in the bolt head accommodating part 24 and the flange accommodating part 23 of the socket 13.

In ST02, the rotating shaft is caused to rotate. Specifically, in FIG. 1, the rotating shaft 11 is caused to rotate in the direction shown by the arrow in a state in which the flange bolt 20 (see FIG. 2) is fitted in the socket 13.

In ST03, air is blown in the space between the head of the bolt and the flat washer. Specifically, air is discharged between the head 21 of the bolt and the first surface 31 of the flat washer 30 from the air blow nozzle 15, as shown in FIG. 5A.

In ST04, the object to be fastened is fastened by the bolt. Specifically, in FIG. 4, the socket 13 is caused to rotate in the fastening direction of the bolt, and the flange bolt 20 is thereby fastened to the object 34 to be fastened.

In the flowchart of FIG. 6, the shaft rotating step (ST02) is shown to be followed by the air blowing step (ST03). The order of these steps may be reversed. That is, the shaft rotating step (ST02) may come after the air blowing step (ST03) to produce the same results.

In the air blowing step of the bolt-fastening method, the blown air has a cleaning effect since the air is blown in the space between the head 21 of the bolt and the flat washer 30 from the air blow nozzle 15, as shown in FIG. 5A. Consequently, no concerns are presented that foreign matter will adhere to the flat washer or the head of the bolt. As another result, only a small amount of the air needs to be discharged from the air blow nozzle 15, and electricity expenses incurred by the compressor can be reduced.

The bolt-fastening apparatus 10 of the first embodiment depicts an example in which the air blow nozzle 15 is provided to the holder 12. However, protrusions or other obstructions are often formed in the periphery of threaded holes in variety of machines and constructions, and the socket must protrude farther than the air blow nozzle in order to fasten a bolt in such threaded holes.

The second embodiment will be described below. In the second embodiment, an air blow nozzle is capable of being moved in the rearward direction when an obstruction comes in contact therewith.

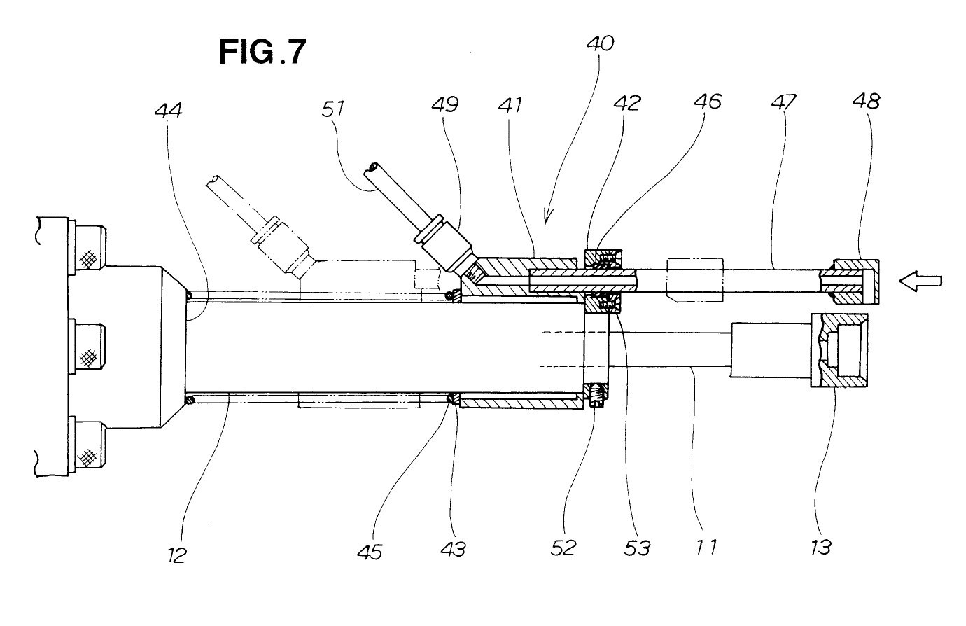

FIG. 7 shows a bolt-fastening apparatus of the second embodiment. The same symbols are used for parts of the structure that are in common with those of the first embodiment shown in FIG. 1, and a description thereof is omitted.

The bolt-fastening apparatus 40 of the second embodiment has a rotating shaft 11; a holder 12; a hollow slider 41, which is fitted on an outer periphery of the holder 12 so as to be capable of moving in the longitudinal direction of the shaft; a stopper member 42, which is attached to a distal end part of the holder 12 in order to restrict the slider 41 from moving forward (to the right in the drawing); a compression coil spring 45, which is provided between a washer 43 that is closely attached to a rear end surface of the slider 41, and a rear part of the holder 12, which is provided to a seat surface 44 and which is fitted on an outer periphery of the holder 12; a socket 13; an air supply tube 47, which is attached to the slider 41, and which is slidably supported by a slide member 46 that is provided to the stopper member 42; and an air blow nozzle 48, which is attached to a distal end of the air supply tube 47.

Reference numeral 49 indicates a tube joint. Reference numeral 51 indicates a flexible tube. Reference numeral 52 indicates a cap screw for the stopper member. Reference numeral 53 is a cap for the stopper member.

When a horizontal load is applied to a distal end surface of the air blow nozzle 48 as shown by an outlined arrow the, with the rotating shaft 11, the holder 12, and the socket 13 in a stationary state, then the air blow nozzle 48, the air supply tube 47, and the slider 41 will move rearward (to the left in the drawings), and stop at the position indicated by the double dashed line, for example. The compression coil spring 45 transitions from an extended state to a compressed state.

When the horizontal load shown by the outlined arrow is removed from this state, the air blow nozzle 48, the air supply tube 47, and the slider 41 return to the position indicated by the solid line as a result of the elasticity of the compression coil spring 45.

Specifically, in the bolt-fastening apparatus 40, the slider 41 is configured so as to slide rearward (to the left in the drawing) along the outer periphery of the holder 12 when subjected to a horizontal load due to an obstruction coming in contact with the air blow nozzle 48.

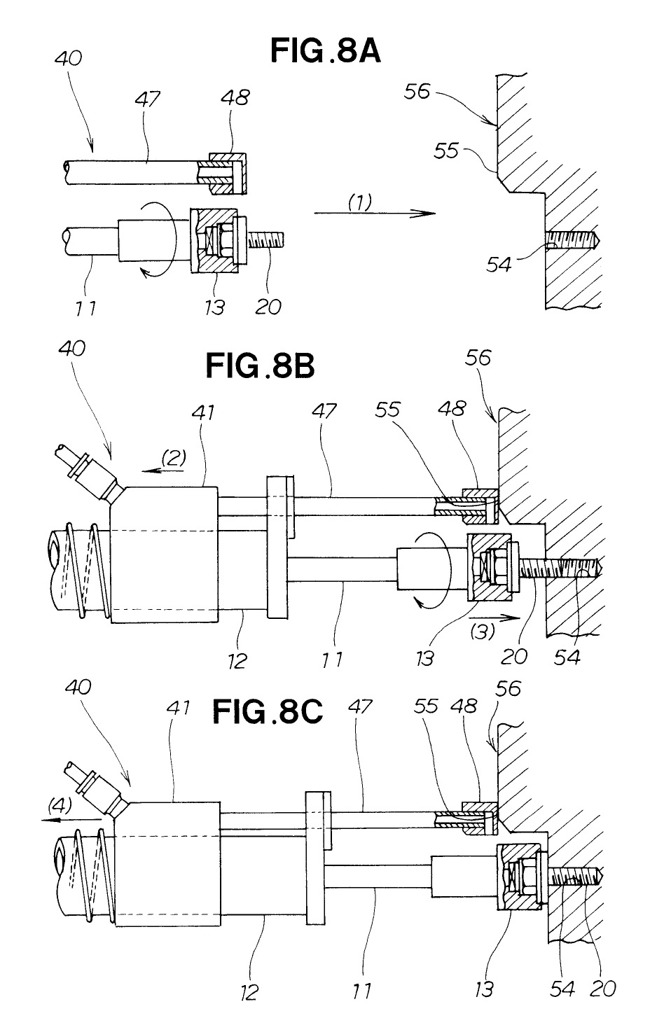

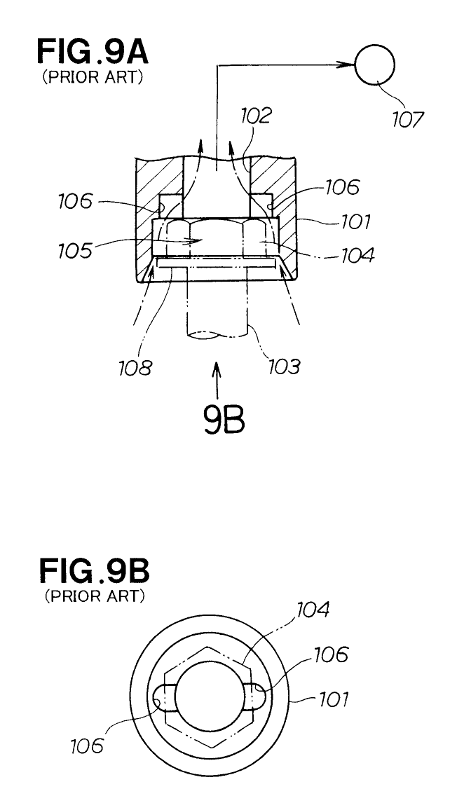

An action of the bolt-fastening apparatus 40 of the second embodiment will be described below with reference to FIGS. 8A through 8C.

In FIG. 8A, a bolt-fastening apparatus 40 having a flange bolt 20 inserted therein and a rotating shaft 11 that is caused to rotate is positioned facing an object 56 to be fastened and has a threaded hole 54 and a protruding part 55. The bolt-fastening apparatus 40 is made to advance as shown in the direction shown by arrow (1).

In FIG. 8B, the air blow nozzle 48 comes in contact with a protruding part 55, and the slider 41 is made to retract as shown by arrow (2). The socket 13 simultaneously moves forward as shown by arrow (3), and the flange bolt 20 is threaded into the threaded hole 54.

In FIG. 8C, the fastening of the flange bolt 20 is completely fastened in the threaded hole 54. The rotating of the rotating shaft 11 is stopped, the entire bolt-fastening apparatus 40 is retracted as shown by arrow (4), and the apparatus is transferred to the next operation.

According to the bolt-fastening apparatus 40 of the second embodiment, the socket 13 can thus protrude farther than the air blow nozzle 48 because the slider 41 is configured so as to slide rearward along the outer periphery of the holder 12 when a protruding part 55 comes in contact with the air blow nozzle 48. The flange bolt 20 can thereby be sufficiently fastened, even in cases where protrusions or other obstructions are present in the periphery of the threaded hole 54 provided to the object 56 to be fastened.

In the first embodiment and the second embodiment, a flanged bolt is described by way of example, but a flangeless hexagon-headed bolt may also be used in the present invention. However, in a case where a normal hexagon-headed bolt is used, the flange accommodating part 23 depicted in FIG. 2 is omitted.

The obstruction indicated in the second embodiment is described, by way of example, as a protrusion on the periphery of the threaded hole, but may also apply to a step part of a threaded hole formed by counterboring. Accordingly, the obstruction may apply to peripheral parts of threaded holes provided to ordinary machines and constructions.

Obviously, various minor changes and modifications of the present invention are possible in light of the above teaching. It is therefore to be understood that within the scope of the appended claims the invention may be practiced otherwise than as specifically described.

1. A bolt-fastening apparatus for holding, conveying and rotating a washered bolt with a flat washer passed therethrough, the apparatus comprising:
a rotating shaft;
a holder for rotatably supporting the rotating shaft;
a socket provided to a distal end of the rotating shaft and designed to accommodate a head of the bolt; and
an air blow nozzle provided to the holder for blowing air into a space between the head of the bolt accommodated in the socket and the flat washer.

2. The bolt-fastening apparatus of claim 1, wherein the flat washer has a first surface facing the bolt head and an oppositely faced second surface, and the air blow nozzle is provided near the holder so as not to protrude from the second surface at a reference position where the flat washer is held in contact with the head of the bolt accommodated in the socket.

3. A bolt-fastening apparatus for holding, conveying and rotating a washered bolt with a flat washer passed therethrough, the apparatus comprising:
a rotating shaft;
a holder for rotatably supporting the rotating shaft;
a hollow slider fitted on an outer periphery of the holder longitudinally movably;
a socket provided to a distal end of the rotating shaft and designed to accommodate a head of the bolt; and
an air blow nozzle attached to the slider for blowing air in a space between the head of the bolt accommodated in the socket and the flat washer,
the slider being slidable longitudinally rearwardly of the holder when an obstruction comes in contact with the air blow nozzle.

4. A method for fastening a washered bolt with a flat washer passed therethrough, comprising the steps of:
accommodating a head of the washered bolt inside a socket;
causing a rotating shaft, which supports the socket, to rotate;
blowing air from an air blow nozzle into a space between the head of the bolt accommodated in the socket and the washer; and
fastening the bolt to a fastening object.

5. A method for fastening a washered bolt with a flat washer passed therethrough, comprising the steps of:
accommodating a head of the washered bolt inside a socket;
blowing air from an air blow nozzle into a space between the head of the bolt accommodated in the socket and the washer;
causing a rotating shaft, which supports the socket, to rotate; and
fastening the bolt to a fastening object.
